(19) United States
(12) Patent Application Publication
(10) Pub. No.: US 2012/0269359 A1
(43) Pub. Date: Oct. 25, 2012

(54) MEDIA DISTRIBUTION SYSTEM

(75) Inventor: Gary Spittle, Cambridge (GB)

(73) Assignee: CAMBRIDGE SILICON RADIO LIMITED, Cambridge (GB)

(21) Appl. No.: 13/271,428

(22) Filed: Oct. 12, 2011

(30) Foreign Application Priority Data
Nov. 1, 2010 (GB) 1018360.6

(51) Int. Cl. H04B 3/00

(52) U.S. Cl. 381/77

(57) ABSTRACT

A system and method for distributing audio data from a first audio output device to a second audio output device. The first audio output device receives data from a data source, outputs the data as audio to a user, and transmits the data to the second audio output device for output to a second user. A system and method for conducting conference calling utilising a single wireless connection to a telephone are also disclosed.

### RELATED APPLICATION DATA

This application claims the benefit of UK Application No. 1018360.6, filed on Nov. 1, 2010, the disclosure of which is incorporated herein by reference in its entirety.

### BACKGROUND

Apparatus and methods for distributing media data to more than one recipient are disclosed.

Portable electronic devices are widely available for storing and outputting media data for users to listen to via speakers or headphones. For example, the so-called MP3 player has become a ubiquitous accessory.

Headphones or speakers receive signals from the portable device either via a wired or a wireless connection. Bluetooth® is a popular wireless protocol for wireless connections. Both wired and wireless connection types suffer a disadvantage as they are one-to-one connections and therefore only enable output of audio to a single set of headphones or speaker device. Although it is possible to split a wired connection to share the output this is typically unattractive as it presents physical difficulties due to the connection of both people to the portable device. Wireless connections providing broadcast functions are also available, for example low-power FM transmitters may be utilised. However, such transmitters are not widely utilised and potentially lead to licensing difficulties, both in terms of usage of the FM radio spectrum, and the unlicensed broadcast of audio data. Furthermore, a system utilising multiple one-to-one connections between a portable device and multiple output devices significantly increases hardware complexity and power consumption of the portable device.

There is therefore a requirement for a system to enable the distribution of audio data to multiple listeners.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided an audio output device, comprising a first communications module, configured to receive data representative of audio via a first communications link; at least one speaker in communication with the first communications module configured to output audio represented by the data received by the first communications module; a second communications module, configured to establish a wireless connection with a second audio output device and to transmit data representative of audio to that second audio output device.

The audio output device may further comprise a decoder in communication with the first communications module and the at least one speaker, wherein the decoder is configured to decode the received data for output by the at least one speaker.

The first communications module may be a wireless receiver configured to establish a wireless connection with a data source.

The first communications module may comprise a Bluetooth receiver configured to establish a Bluetooth connection with, and receive data from, the data source.

The second communications module may comprise a Bluetooth transmitter configured to establish a Bluetooth wireless connection with the second audio output device.

The audio output device may be a headset further comprising a microphone, wherein the second communications module is configured to mix audio data from the microphone with the received data, and output the mixed data via the wireless connection to the second audio output device.

The second communications module may be in communication with the at least one speaker and is configured to receive second data representative of audio from the second audio output device via the wireless connection, and the audio output device is configured to mix the second data with the received data and to output audio represented by the mixed signal by the at least one speaker.

The first communications module may be configured to transmit data representative of audio via the first communications link.

The data transmitted via the first communications link may comprise data representative of the audio output by the speaker of the audio output device.

There is also provided a method of distributing audio data performed by a first audio output device, the method comprising the steps of receiving first data representative of audio via a first communications link; outputting the audio represented by the first data; transmitting data representative of the audio to a second audio output device, via a second communications link, wherein the second communications link is a wireless communications link.

The first communications link may be a wireless communications link.

The method may further comprise the steps of decoding the received data for output by the first audio output device, and encoding the decoded data prior to transmission to the second audio output device.

The method may further comprise the steps of receiving second data representative of audio via the second communications link; and mixing the second data with the first data, wherein the step of outputting the audio comprises outputting audio represented by the mixed data, and wherein the transmitted data is representative of the mixed data.

The method may further comprise the step of mixing the first data and/or second data with data representative of audio received by a microphone of the first audio output device, and wherein the step of outputting the audio comprises outputting audio represented by the mixed data, and wherein the transmitted data is representative of the mixed data.

The method may further comprise the step of transmitting data representative of the audio output by the first audio device via the first communications link.

There is also provided a headset comprising a microphone and a speaker, comprising a first wireless communications module, configured to establish a first wireless connection with a first communications device and to receive and transmit first data representative of audio via the first connection, a second wireless communications module, configured to establish a second wireless connection with a second communications device and to receive and transmit second data representative of audio via the second connection, and a mixer component configured to mix the first and second data with data from the microphone, and to output the mixed data to the speaker and to the first and second wireless communications modules for transmission via the first and second wireless connections.

The headset may further comprise a decoder configured to decode the first and/or second data prior to mixing.

The headset may further comprise a coder configured to code the at least one output of the mixer prior to transmission of the data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1a and 1b show examples of wired and wireless portable electronic devices;

FIG. 2 show a schematic diagram of a system for distributing audio data;

FIG. 3 shows a flow chart of a method of distributing audio data;

FIGS. 4 and 5 show a block diagram of a process for outputting and distributing audio data;

FIG. 6 shows a schematic diagram of a system for distributing audio data;

FIG. 7 shows a flow chart of a method of distributing audio data;

FIG. 8 shows a schematic diagram of a system for enabling a conference call;

FIG. 9 shows a schematic diagram of a mixing system for the distribution of audio data; and

FIG. 10 shows a schematic diagram of a system for enabling a conference call.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

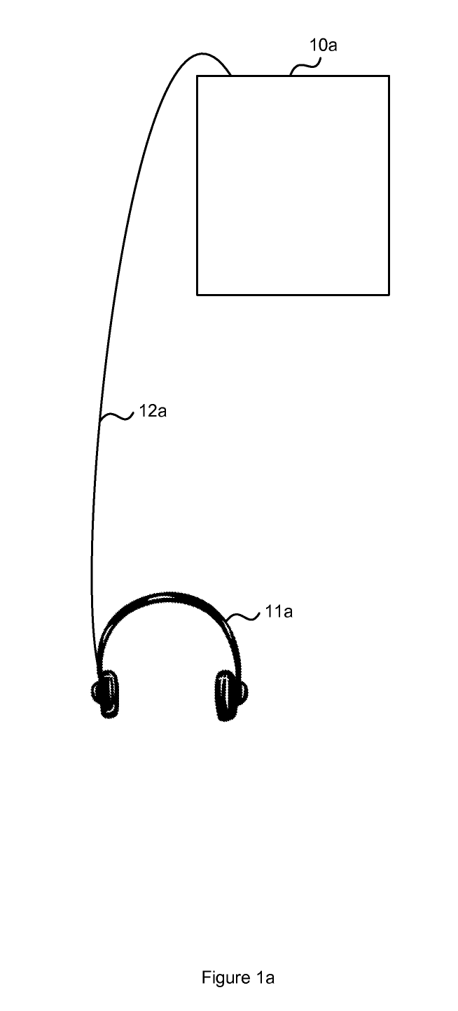

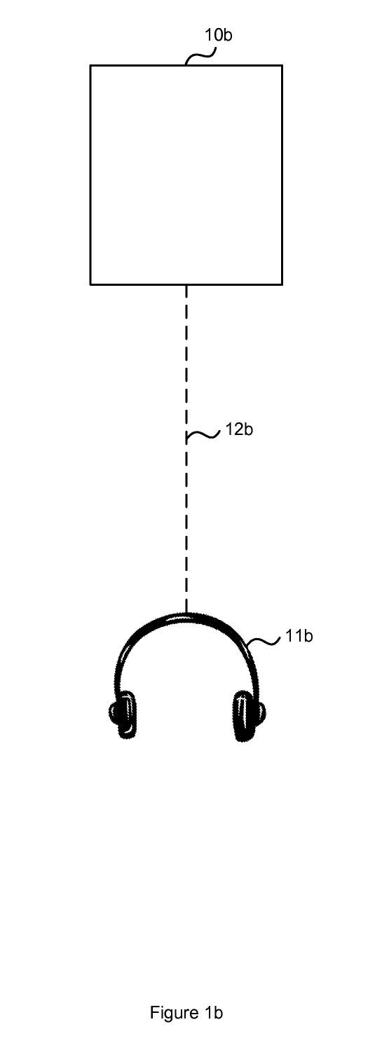

FIGS. 1a and 1b show two schematic diagrams of portable electronic devices for outputting audio data to headphones for a user to listen to. In FIG. 1a the portable electronic device 10a is connected to the headphones 11a via a wired connection 12a. The portable electronic device 10a may output the audio data in an analogue format to drive speakers in the headphones 11a directly, or may output a coded digital signal which is decoded by a processing system in the headphones 11a and output as audio to the user. In FIG. 1b the portable electronic device 10b is connected to the headphones 11b via a wireless Bluetooth® connection 12b. The audio data is received by the headphones 11b, decoded by a processing system in the headphones 11b and output as audio to the user.

As discussed above, the systems of FIG. 1 can only be extended to distribute audio data to multiple users by providing additional connections between the portable electronic device and additional headphones, which is complex and inefficient.

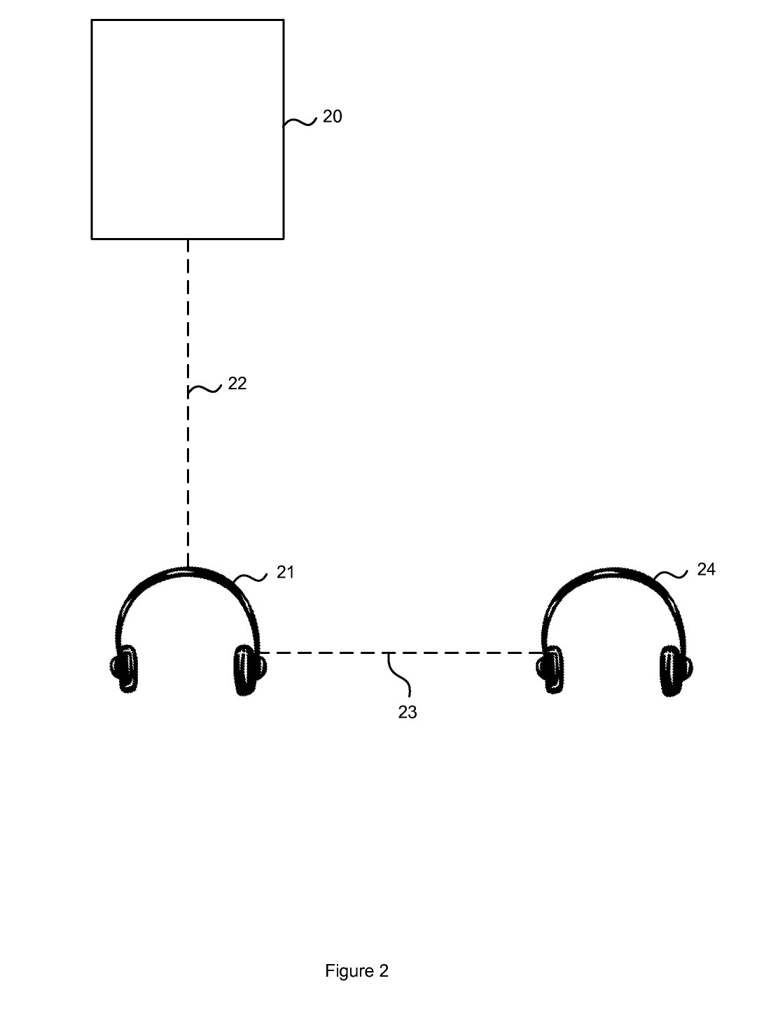

FIG. 2 shows a system for enabling the output of audio data to multiple users. Portable electronic device 20 is connected to first headphones 21 in the conventional manner utilising a wireless Bluetooth® connection 22. A second Bluetooth® connection 23 is also established by the first headphones 21 with second headphones 24 for use by a second user. First headphones 21 are configured to receive audio data via the first Bluetooth® connection 22 and output it to the second headphones 24 via the second Bluetooth® connection 23. The audio data from the portable electronic device 20 is thereby distributed to multiple users, without requiring the establishment of multiple connections from the portable electronic device 20, and without utilising a broadcast system.

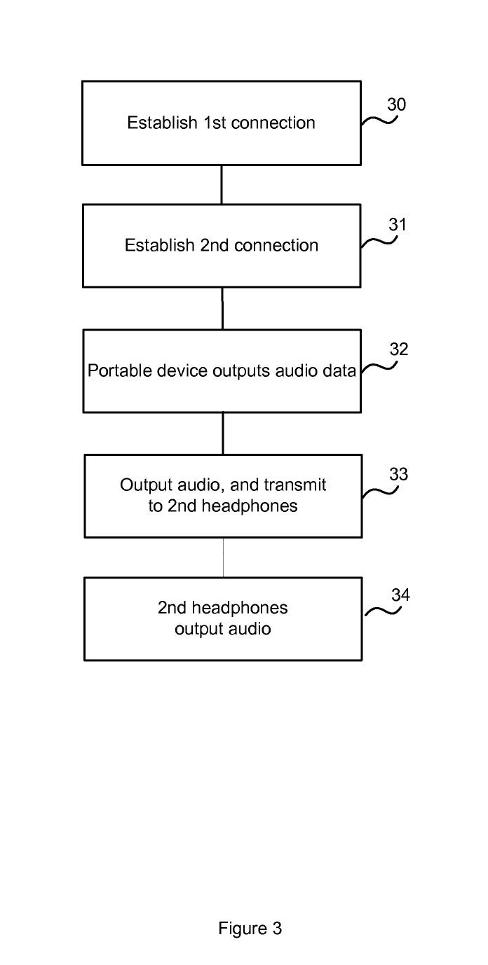

FIG. 3 shows a flow diagram of a method of distributing audio data utilising the system of FIG. 2. At block 30 a first Bluetooth® connection 22 is established between the portable electronic device 20 and the first headphones 21 to enable the transmission of audio data from the portable electronic device 20 to the first headphones 21. The first connection 22 may be established in any conventional manner, for example in response to input from the user, or the devices detecting their proximity. At block 31 the user of the first headphones 21 instructs a second Bluetooth® connection 23 between first headphones 21 and second headphones 24 to be established, which is duly performed. For example, a button may be provided on first headphones 21 to cause the establishment of connection 23, or any other known method may be utilised.

At block 32 the portable electronic device 20 commences outputting audio data via connection 22 to first headphones 21. At block 33, first headphones 21 output the audio to the user, and also transmit the data via second connection 23 to second headphones 24. At block 34, second headphones 24 also output the audio to a user of those headphones. The audio data from the portable electronic device 20 is thereby distributed to both sets of headphones without placing any additional burden or complexity on the portable electronic device 20.

The two Bluetooth® connections may be provided by a single communications system provided in the headphones, for example a Bluetooth® chip capable of establishing two connections, or two chips each establishing one connection. The chips may also provide other processing functions as is known in the art. The form of the wireless links is selected depending on the protocol implemented and data to be transmitted. For example, in a Bluetooth® system ACL links may be utilised as defined by the Bluetooth® protocols.

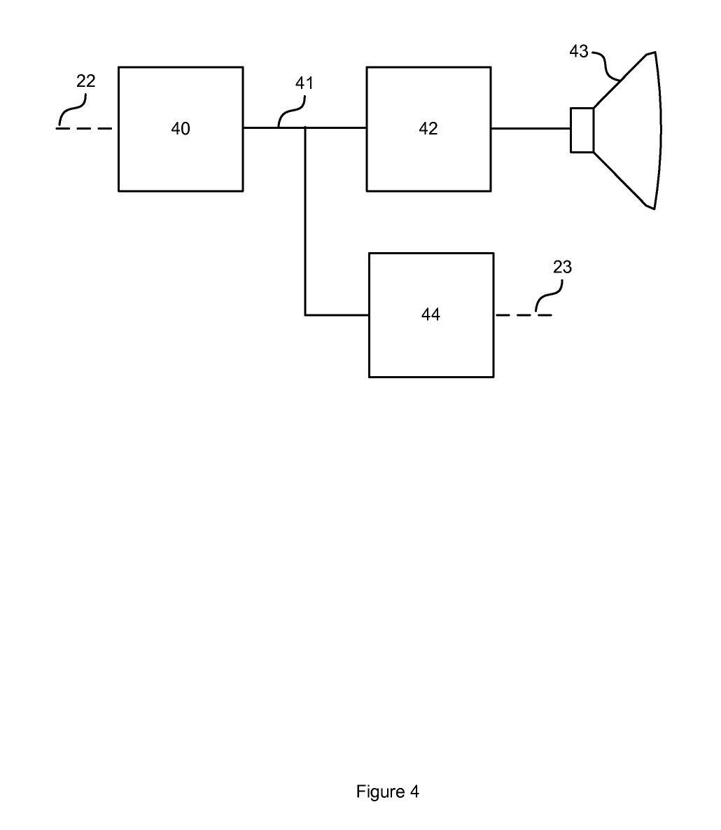

FIG. 4 shows a block diagram of processing performed by first headphones 21. Data is received from the Bluetooth® connection by receiver 40 which processes the received signal and outputs 41 the audio data as sent by the portable electronic device. The data is typically an encoded representation of the audio signal, for example an SBC or MP3 encoding. A decoding system 42 decodes the encoded data and outputs an analogue signal to speakers 43 for the user to listen to. Data 41 is also passed to a transmission system 44 which establishes and maintains the second Bluetooth® connection. Transmission system 44 receives the encoded audio data and outputs it via the second connection. The data is therefore received by the second headphones in the same format in which it is transmitted by the portable electronic device.

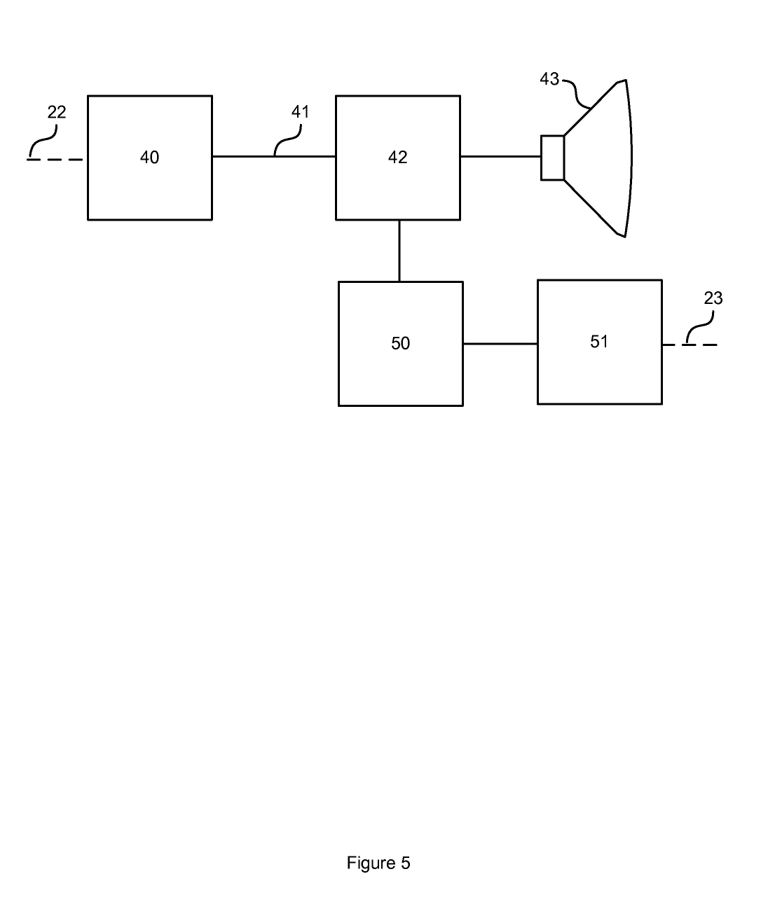

FIG. 5 shows a block diagram of alternative processing preferred by headphones 21. References 40, 41, 42, and 43 are the same as FIG. 4. However, decoding system 42 outputs a decoded version of the audio data to coding system 50 which codes the data into a format for transmission to the second headphones. Coding system 50 outputs the coded data to the second transmission system 51 for transmission to the second headphones as explained above. The process of FIG. 5 enables transcoding of media files by the headphones, for example where first headphones 21 receive the audio data in a different format to that required by the second headphones 24. Decoding system 42 may also perform other processing on the audio data, for example to enhance the quality of the audio. In the system of FIG. 5, the data passed to coding system 50 may be the output of such processing steps, thereby enabling the second user to also benefit from the processing. As will be appreciated, the blocks of FIGS. 4 and 5 are shown for convenience to describe the functions performed and do not necessarily represent the actual division of functions performed to achieve the desired result. Similarly, although first and second transmission systems have been described, these functions may be provided by a single system.

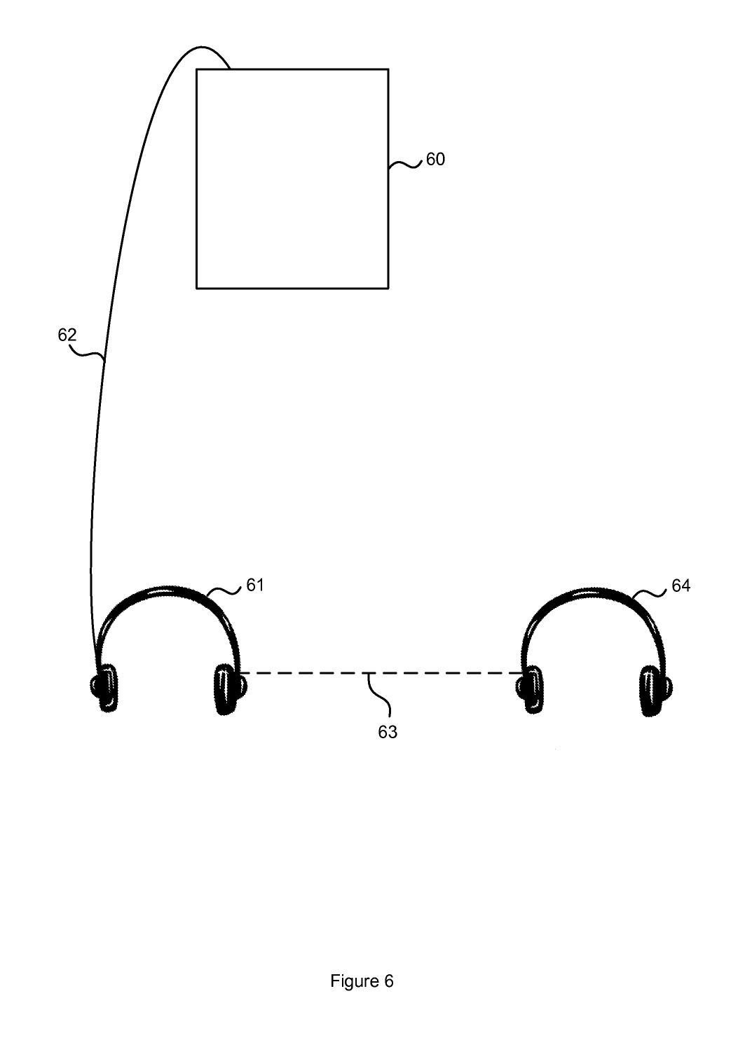

FIG. 6 shows an alternative system for the distribution of audio data. Portable electronic device 60 is connected to first headphones 61 by a wired connection 62. A Bluetooth® connection 63 is also established between the first headphones 61 and second headphones 64.

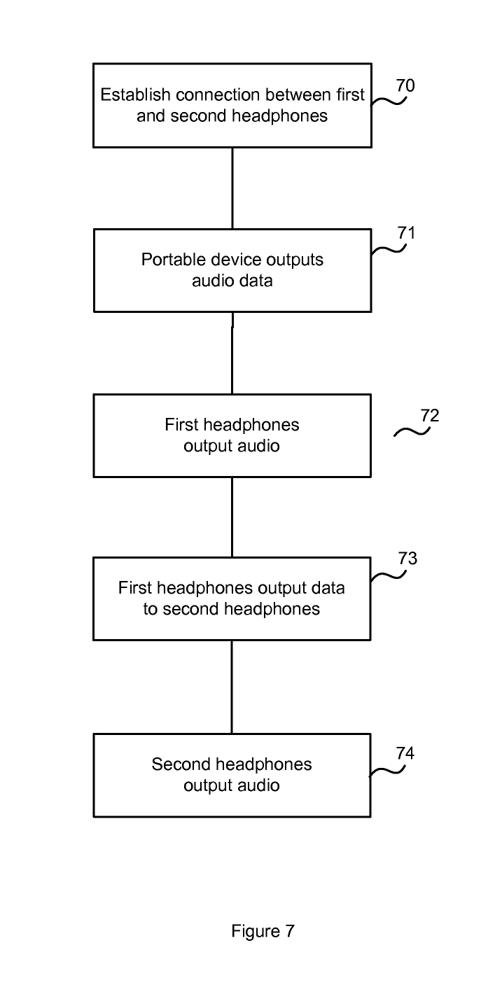

FIG. 7 shows a flow diagram of a method of distributing audio data utilising the system of FIG. 6. At block 70 a Bluetooth® connection 63 is established between first headphones 61 and second headphones 64. At block 71 the portable electronic device 60 outputs audio data via wired connection 62 which is received by first headphones 61. At block 72 first headphones 61 decode and output the audio data for the user to listen to. At block 73 first headphones 61 output the audio data via connection 63 to the second headphones 64. At block 74 second headphones 64 decode and output the audio for the second user to listen to. Distribution of audio data to a second user is therefore achieved without requiring a further wired connection to the portable electronic device 60, and without requiring that device to be equipped with a wireless broadcast system.

In the system of FIG. 6, the portable electronic device may output the audio data via the wired connection as an analogue signal for direct output by the headphones 61. In this case, headphones 61 sample and encode the audio data into an encoded digital signal prior to transmission to the second headphones 64. In a different embodiment, the portable electronic device may output the audio in an encoded format via the wired connection, in which case the first headphones process the data as per the methods described with reference to FIGS. 4 and 5 above when the data is received via a wireless connection.

The above examples have been given by way of an example utilising a portable electronic device and headphones for the output of audio data, but as will be appreciated many variations may be utilised without departing from the principles described herein. For example, speakers may be utilised in place of the headphones, and a non-portable media player may be utilised in place of the portable electronic device. Similarly, the same systems and methods may be utilised to share other types of data, for example visual media data.

The number of channels of audio information transmitted by each link may be consistent or may be varied. For example, two channels representing stereo audio may be transmitted from the portable electronic device to the first set of headphones, but only a single channel may be transmitted to the second set of headphones.

As noted above, the system may be utilised to output audio data from speakers in place of the headphones. For example, the first headphones may be replaced by a full-range speaker, and the second headphones by a sub-woofer speaker. In this example, three channels (left, right, and sub-woofer) of audio information are transmitted to the first audio output device, and only the sub-woofer channel is transmitted to the second audio output device. Other combinations of channels may be utilised as required by the particular system without departing from the principles of the system disclosed herein.

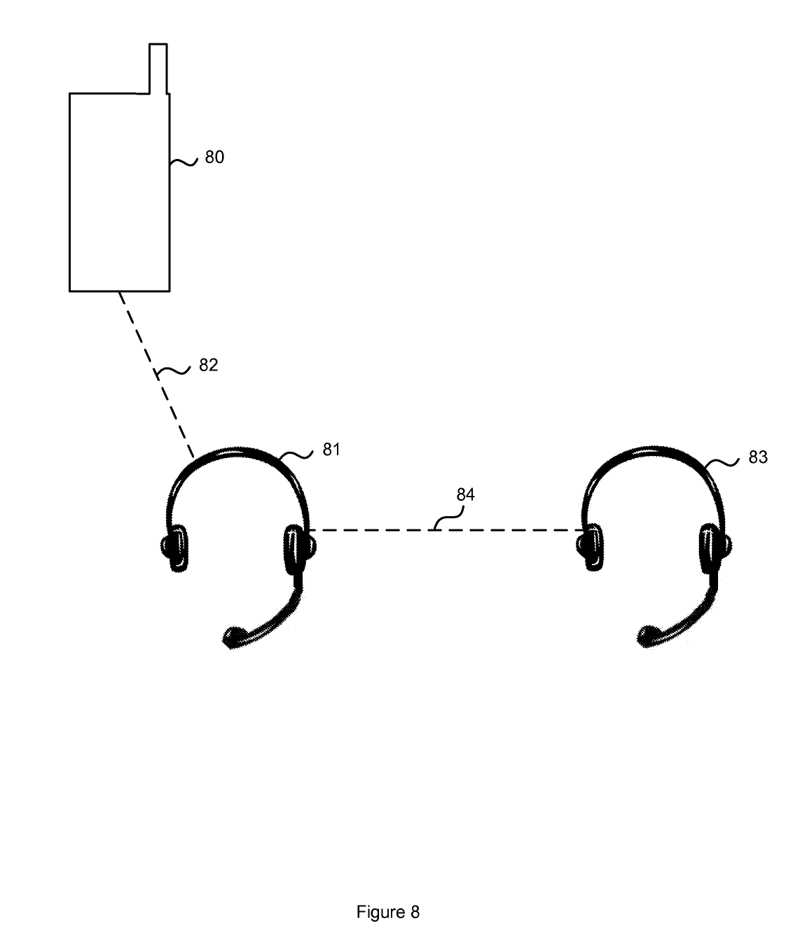

FIG. 8 shows a mobile telephone 80 which is connected to a first headset 81 via a first Bluetooth® connection 82. The first headset 81 comprises speakers for outputting audio to a user, and a microphone for accepting audio input from a user. Connection 82 is a two-way connection such that audio data can be transferred from the telephone 80 to the first headset 81 and output to the user, and audio data can be transferred from the microphone to the telephone 80. The components 80, 81, 82 therefore form a conventional hands-free mobile telephone system. The Bluetooth® connections may utilise SCO links, as defined by the Bluetooth® protocols.

The first headset 81 is also connected to a second headset 83 by a second Bluetooth® connection 84. This system enables two users to participate in a telephone call using the telephone 80, without requiring multiple connections between the telephone 80 and each user. Furthermore, the system may be utilised to allow the two users to communicate with each other, in the absence of an active telephone connection.

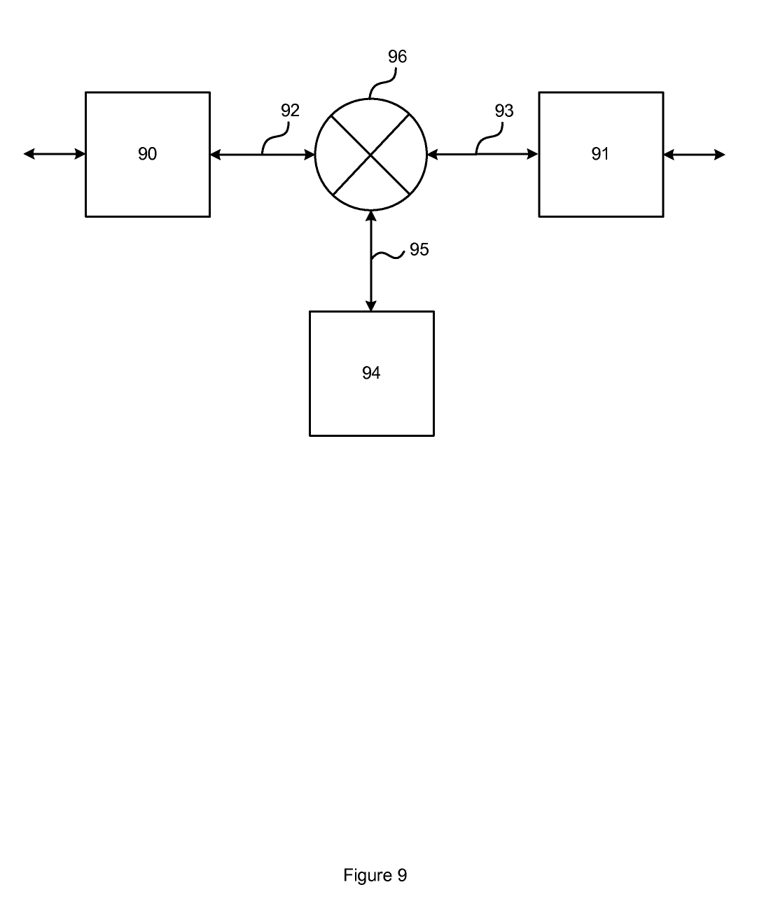

FIG. 9 shows a block diagram of headset 81 which provides the functionality noted above with reference to FIG. 8. Transmission system 90 maintains a Bluetooth® connection 82 with the mobile telephone 80, and a second transmission system 91 maintains a second Bluetooth® connection 84 with the second headset 83. The first and second transmission systems output and receive audio data as signals 92 and 93 respectively. The microphone and speaker of headset 81 are represented by block 94, which outputs and receives audio data via signal 95. The signals 92, 93 and 95 are arranged to be in a compatible format. Each of the signals 92, 93 and 95 are connected to mixer 96, which accepts each of the inputs and mixes them together, passing the resulting signal to each of the outputs. Different processing may be applied to each of the signals and outputs as required by the particular system. For example the relative levels applied during mixing may be altered. Audio data from the mobile telephone 80, and both headsets 81, 83, is therefore mixed together and transmitted to each of those devices for output or further processing. Each of the users with the headsets, and remote users connected via a communications link to mobile telephone 80 can therefore all hear and speak to each other.

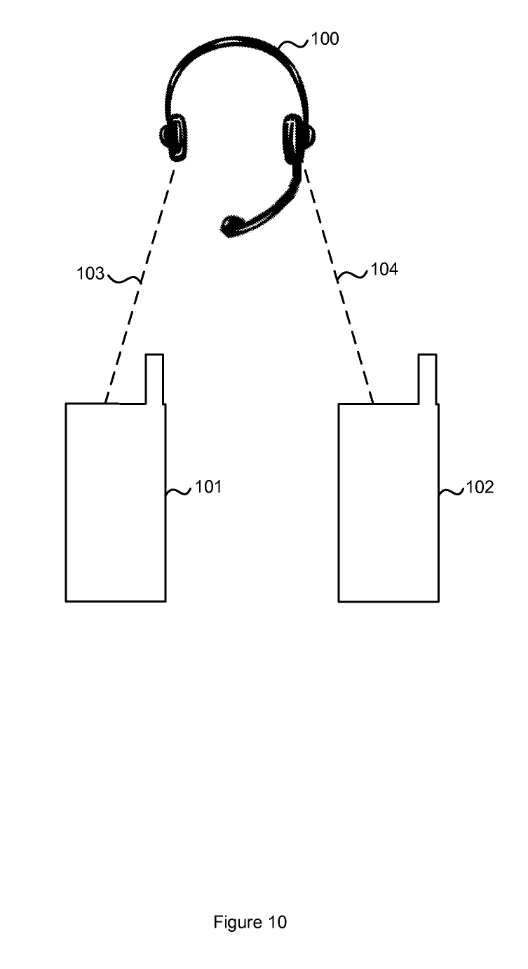

FIG. 10 shows a schematic diagram of a system for allowing a conference call to be performed utilising a single headset 100 and a pair of mobile telephones 101, 102. The headset 100 is connected to a first mobile telephone 101 by a first Bluetooth® connection 103, and to a second mobile telephone 102 by a second Bluetooth® connection 104. Headset 100 operates as shown in FIG. 9, but transmission system 90 maintains the first connection 103 to the first telephone 101, and the second transmission system 91 maintains the second connection 104 to the second telephone 102. The mixer 96 enables participants connected via mobile telephones 101 and 102, and the user wearing the headset 100, to all hear and speak to each other and thereby participate in a conference call.

Where the above description makes reference to mixing data representative of audio, it will be appreciated that it is intended to refer to a mixing process to achieve a mixing of the audio represented by the data. The mixing may be performed in any suitable way depending on the particular form of the data. For example, analogue signals may be mixed directly, but encoded signals may be first decoded, a digital mixing performed, then recoded into the required encoding format. Furthermore, processing may be performed during the mixing, for example to adjust the relative levels of the each of the signals, or to perform audio-enhancement techniques on one or all of the signals.

The above examples have utilised Bluetooth® connections as an example of a suitable wireless connection, but as will be appreciated any form of wireless connection system may be utilised in the place of the Bluetooth® connection without requiring modification of the systems and methods described herein. Another example of a wireless protocol is the Wi-Fi direct protocol.

The term ‘processing system’ is used herein to refer to any device with processing capability such that it can execute instructions. Those skilled in the art will realize that such processing capabilities are incorporated into many different devices, ICs, chips and components and therefore the term includes, for example, all types of micro-processors, CPUs, GPUs, DSPs, and multifunction chips.

The methods described herein may be performed by software in machine readable form on a tangible storage medium e.g. in the form of a program comprising program code means adapted to perform all the steps of any of the methods described herein when the program is run on a processing system and where the program may be embodied on a readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. Features of each embodiment may be considered in any functioning combination.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention, including combining features disclosed in respect of one embodiment with features disclosed in respect of a second embodiment.

What is claimed is:

1. An audio output device, comprising
a first communications module, configured to receive data representative of audio via a first communications link;
at least one speaker in communication with the first communications module configured to output audio represented by the data received by the first communications module;
a second communications module, configured to establish a wireless connection with a second audio output device and to transmit data representative of audio to that second audio output device.

2. An audio output device according to claim 1, further comprising a decoder in communication with the first communications module and the at least one speaker, wherein the decoder is configured to decode the received data for output by the at least one speaker.

3. An audio output device according to claim 1, wherein the first communications module is a wireless receiver configured to establish a wireless connection with a data source.

4. An audio output device according to claim 3, wherein the first communications module comprises a Bluetooth receiver configured to establish a Bluetooth connection with, and receive data from, the data source.

5. An audio output device according to claim 1, wherein the second communications module comprises a Bluetooth transmitter configured to establish a Bluetooth wireless connection with the second audio output device.

6. An audio output device according to claim 1, wherein the audio output device is a headset further comprising a microphone,
wherein the second communications module is configured to mix audio data from the microphone with the received data, and output the mixed data via the wireless connection to the second audio output device.

7. An audio output device according to claim 1, wherein
the second communications module is in communication with the at least one speaker and is configured to receive second data representative of audio from the second audio output device via the wireless connection, and the audio output device is configured to mix the second data with the received data and to output audio represented by the mixed signal by the at least one speaker.

8. An audio output device according to claim 6, wherein the first communications module is configured to transmit data representative of audio via the first communications link.

9. An audio output device according to claim 8, wherein the data transmitted via the first communications link comprises data representative of the audio output by the speaker of the audio output device.

10. A method of distributing audio data performed by a first audio output device, the method comprising the steps of
receiving first data representative of audio via a first communications link;
outputting the audio represented by the first data;
transmitting data representative of the audio to a second audio output device, via a second communications link, wherein the second communications link is a wireless communications link.

11. A method according to claim 10, wherein the first communications link is a wireless communications link.

12. A method according to claim 10, further comprising the steps of
decoding the received data for output by the first audio output device, and
encoding the decoded data prior to transmission to the second audio output device.

13. A method according to claim 10, further comprising the steps of
receiving second data representative of audio via the second communications link; and
mixing the second data with the first data, wherein the step of outputting the audio comprises outputting audio represented by the mixed data, and wherein the transmitted data is representative of the mixed data.

14. A method according to claim 10, further comprising the step of mixing the first data and/or second data with data representative of audio received by a microphone of the first audio output device, and wherein the step of outputting the audio comprises outputting audio represented by the mixed data, and wherein the transmitted data is representative of the mixed data.

15. A method according to claim 10, further comprising the step of transmitting data representative of the audio output by the first audio device via the first communications link.

16. A headset comprising a microphone and a speaker, comprising
a first wireless communications module, configured to establish a first wireless connection with a first communications device and to receive and transmit first data representative of audio via the first connection,
a second wireless communications module, configured to establish a second wireless connection with a second communications device and to receive and transmit second data representative of audio via the second connection, and
a mixer component configured to mix the first and second data with data from the microphone, and to output the mixed data to the speaker and to the first and second wireless communications modules for transmission via the first and second wireless connections.

17. A headset according to claim 16, further comprising a decoder configured to decode the first and/or second data prior to mixing.

18. A headset according to claim 16, further comprising a coder configured to code the at least one output of the mixer prior to transmission of the data.
